(19) United States
(12) Patent Application Publication
(10) Pub. No.: US 2015/0328997 A1
(43) Pub. Date: Nov. 19, 2015

(54) WIRELESS POWER-SUPPLYING SYSTEM

(71) Applicant: IHI Corporation, Tokyo (JP)

(72) Inventor: Sho HASHIZUME, Tokyo (JP)

(73) Assignee: IHI CORPORATION, Tokyo (JP)

(21) Appl. No.: 14/710,963

(22) Filed: May 13, 2015

(30) Foreign Application Priority Data
May 16, 2014 (JP) 2014-102503

(51) Int. Cl. B60L 11/18; H02J 5/00

(52) U.S. Cl. CPC B60L 11/182; H02J 5/005

(57) ABSTRACT

A wireless power-supplying system configured to perform wireless power supply using a power-receiving coil and a power-transmitting coil. The wireless power-supplying system includes a power-receiving circuit provided with the power-receiving coil having impedance changer configured to change impedance when requiring stopping the wireless power supply, and a power-transmitting circuit provided with the power-transmitting coil having impedance change detector configured to detect change in impedance by the impedance changer, and the wireless power supply is stopped based on a detection result of the impedance change detector.

### BACKGROUND OF THE INVENTION

1. Field of the Invention

The present invention relates to a wireless power-supplying system.

Priority is claimed on Japanese Patent Application No. 2014-102503, filed on May 16, 2014, the content of which is incorporated herein by reference.

2. Description of Related Art

In recent years, there have been an increasing number of vehicles which are provided with a motor as a power generation source instead of or along with an engine. A representative vehicle with a motor instead of an engine is an electric vehicle (EV), and a vehicle with a motor along with an engine is a hybrid vehicle (HV). Such vehicles include a rechargeable device (for example, a secondary battery, such as a lithium-ion battery or a nickel-hydrogen battery) which supplies electric power for driving the motor, and are configured to be charged with electric power supplied from an external power source.

In an electric vehicle or a hybrid vehicle (specifically, a plug-in hybrid vehicle) in practical use, electric power for charging a rechargeable device has been mostly transmitted through a cable which connects a power source and a vehicle. In contrast, in recent years, a method which wirelessly transmits electric power for charging the rechargeable device to a vehicle has been proposed. As the wireless power supply method, an electromagnetic induction method, a radio receiving method, an electric field coupling method, a magnetic field resonance method, and the like are known.

Of these methods, the magnetic field resonance method is a technique in which each of a power-transmitting device and a power-receiving device includes an LC resonance circuit having a coil and a capacitor to resonate a magnetic field between both circuits, thereby wirelessly transmitting electric power (see Japanese Unexamined Patent Application, First Publication No. 2012-55109).

The magnetic field resonance method has a feature in that high-efficiency and long-distance electric power transmission can be realized compared to an electromagnetic induction method which is widely put into practical use. The magnetic field resonance method is attracting attention as a next-generation wireless electric power transmission technique usable for charging an electric vehicle, a hybrid vehicle, or the like.

In this wireless power-supplying system, for example, when any abnormality is detected on the power-receiving device, it is desirable to stop the power transmission from the power-transmitting device. As described above, in a wireless electric power transmission technique, the power-receiving device and the power-transmitting device are not connected by a cable, and in this case, the power-receiving device sends an instruction to stop power transmission to the power-transmitting device using wireless communication (see Paragraph [0043] of Japanese Unexamined Patent Application, First Publication No. 2012-55109).

However, wireless communication has low communication reliability compared to cable communication and is likely to be affected by the ambient environment. For example, if the wireless power supply cannot be stopped immediately due to communication delay, or the wireless power supply cannot be stopped due to communication failure, the system may operate in an undesirable fashion.

### SUMMARY OF THE INVENTION

The invention has been accomplished in consideration of the above-described circumstances, and an object of the invention is to provide a wireless power-supplying system capable of stopping wireless power supply quickly and reliably.

A first aspect of the present invention is a wireless power-supplying system configured to perform wireless power supply using a power-receiving coil and a power-transmitting coil. The system has a configuration in which a power-receiving circuit provided with the power-receiving coil has impedance changer configured to change impedance when requiring stopping the wireless power supply, a power-transmitting circuit provided with the power-transmitting coil has impedance change detector configured to detect change in impedance by the impedance changer, and the wireless power supply is stopped based on a detection result of the impedance change detector.

A second aspect of the present invention is, in the first aspect, the impedance changer has a variable resistor provided in the power-receiving circuit.

A third aspect of the present invention is, in the first or second aspect, the impedance change detector has at least one of a current sensor and a voltage sensor provided in the power-transmitting circuit.

A fourth aspect of the present invention is, in any one of the first to third aspect, the power-receiving circuit is connected to a constant-current/constant-voltage charged type rechargeable device, and the impedance changer changes impedance by a first change step when the rechargeable device is in a constant-current charged mode and changes impedance by a second change step greater than the first change step when the rechargeable device is in a constant-voltage charged mode.

According to the invention, the impedance changer is provided in the power-receiving circuit provided with the power-receiving coil to change the impedance of the power-receiving circuit when requiring stopping the wireless power supply. The change in impedance of the power-receiving circuit causes change in voltage or current in the power-transmitting circuit through the electromagnetic field between the power-receiving coil and the power-transmitting coil. In the invention, the impedance change detector provided in the power-transmitting circuit detects the change as a trigger to stop the wireless power supply. In this way, the wireless power supply is stopped by detecting the change in impedance when the power-receiving circuit is viewed from the power-transmitting circuit, whereby a wireless power-supplying system capable of stopping the wireless power supply quickly and reliably is obtained compared to wireless communication which is likely to be affected by the ambient environment.

### BRIEF DESCRIPTION OF THE DRAWINGS

FIG. 1 is an overall configuration diagram of a wireless power-supplying system according to an embodiment of the invention.

FIG. 2 is a diagram illustrating the circuit configuration of the wireless power-supplying system according to the embodiment of the invention.

FIG. 3 is a flowchart from when abnormality occurs in the wireless power-supplying system until wireless power supply is stopped according to the embodiment of the invention.

### DETAILED DESCRIPTION OF THE INVENTION

Hereinafter, an embodiment of the invention will be described referring to the drawings.

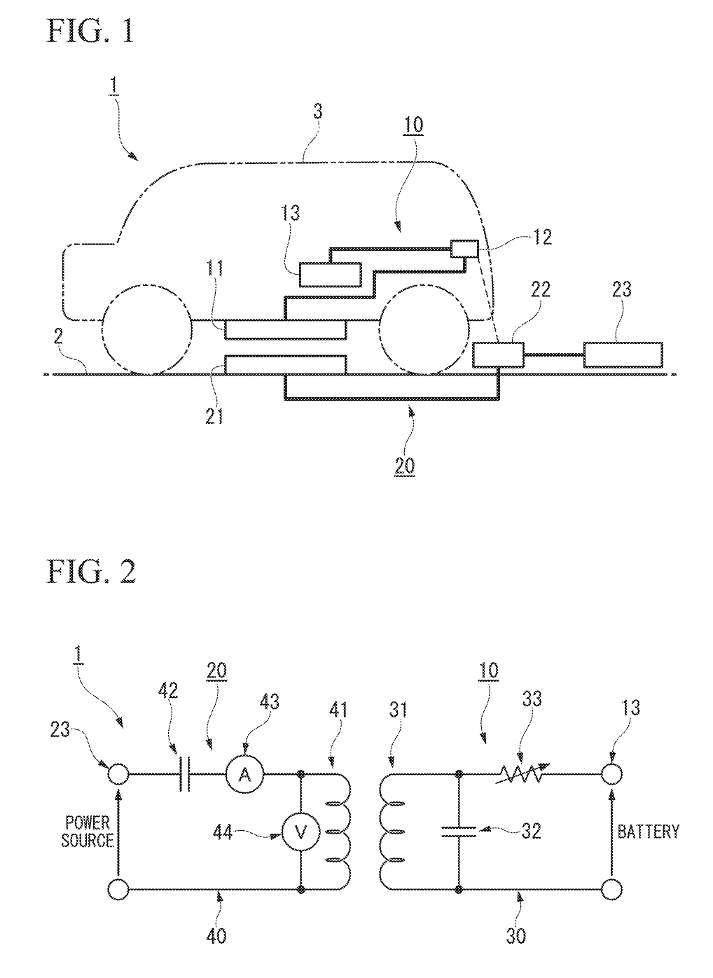

FIG. 1 is an overall configuration diagram of a wireless power-supplying system 1 according to the embodiment of the invention.

The wireless power-supplying system 1 performs wireless power supply between a power-receiving device 10 and a power-transmitting device 20. In this embodiment, as shown in FIG. 1, the power-receiving device 10 is mounted on an automobile 3 which can travel on a road surface 2, and the power-transmitting device 20 is provided on the road surface 2.

The power-receiving device 10 is provided with a power-receiving pad 11 for power reception. The power-transmitting device 20 is provided with a power-transmitting pad 21 for power transmission. The power-receiving pad 11 is provided at the bottom of the automobile 3 so as to be opposed to the power-transmitting pad 21 on the ground. The power-receiving pad 11 has a power-receiving coil (described below) inside a nonmagnetic and nonconductive cover, and wirelessly receives electric power through magnetic coupling of the power-receiving coil with a power-transmitting coil (described below) of the power-transmitting pad 21.

The wireless power supply from the power-transmitting pad 21 to the power-receiving pad 11 in the wireless power-supplying system 1 of this embodiment is performed based on a magnetic field resonance method, an electromagnetic induction method, or the like. The power-transmitting pad 21 and the power-receiving pad 1 respectively have a power-transmitting coil 41 (described below) and a power-receiving coil 31 (described below), and electric power is transmitted by magnetic coupling between the coils. The power-transmitting pad 21 and the power-receiving pad 11 may have capacitors.

The power-receiving device 10 is provided with a power-receiving power conversion circuit 12, in addition to the power-receiving pad 11. A battery 13 (rechargeable device) is connected to the power-receiving power conversion circuit 12. In the power-receiving power conversion circuit 12, a wireless communication device is unitized. The wireless communication device may be separated from the power-receiving power conversion circuit 12.

The power-receiving power conversion circuit 12 is a power conversion circuit which converts received power received by the power-receiving pad 11 from the power-transmitting pad 21 through the wireless power supply to DC power and supplies DC power to the battery 13.

That is, the power-receiving power conversion circuit 12 supplies a current suitable to the battery 13 to the battery 13. Since the battery 13 normally receives DC input, the power-receiving power conversion circuit 12 may include only a rectifier circuit or may further include a DC/DC converter in addition to the rectifier circuit. When an instrument requiring AC input, for example, a load (for example, a motor or the like) using inductance is connected instead of the battery 13, the power-receiving power conversion circuit 12 may have a configuration having an AC/AC exchange function, for example, a combination of a rectifier circuit, a DC/DC converter, and an inverter, or a configuration including a matrix converter or the like. The converter, which is used, may be a non-insulation type (a chopper or the like) or an insulation type (using a transformer or the like). The power-receiving power conversion circuit 12 is connected to a power-receiving controller.

The power-receiving controller includes a central processing unit (CPU), a storage device, an input/output buffer, and the like, receives signals from sensors or the like or outputs control signals to respective instruments, and is, for example, a vehicle electronic control unit (ECU). For example, the power-receiving controller is connected to a battery controller of the battery 13 to acquire electric power necessary for charging the battery 13 or to detect abnormality on the wireless power supply in the automobile 3. The power-receiving controller may be separated from or integrated with the power-receiving power conversion circuit 12.

The wireless communication device performs wireless communication with a wireless communication device provided in an amplifier 22 (described below) through an antenna using a short range communication standard, such as Bluetooth (Registered Trademark).

The battery 13 is a power storage device which is able to store sufficient electric power as a drive power source of the automobile 3, and is, for example, a lithium-ion secondary battery, a nickel-hydrogen secondary battery, a large-capacity electric double-layer capacitor, or the like.

The power-transmitting pad 21 is provided on the road surface 2 so as to be opposed to the power-receiving pad 11. The power-transmitting device 20 is provided with the amplifier 22, in addition to the power-transmitting pad 21. An external power source 23 is connected to the amplifier 22.

The amplifier 22 is a unit which performs AC conversion of electric power supplied from the external power source 23 and outputs the obtained AC power to the power-transmitting pad 21. In the amplifier 22, a power-transmitting DC/AC conversion circuit, a power-transmitting power conversion circuit, a power-transmitting controller, and a wireless communication device are unitized. The power-transmitting controller and the wireless communication device may be separated from the amplifier 22.

The power-transmitting DC/AC conversion circuit is an inverter circuit on the power-transmitting side of the wireless power-supplying system 1, includes a circuit, such as a half-bridge or a full-bridge, which is generally used, converts DC power supplied from the power-transmitting power conversion circuit to AC power, and supplies AC power to the power-transmitting pad 21. As the inverter circuit, a type in which the gate of a semiconductor power element, such as a power metal-oxide-semiconductor field-effect transistor (MOSFET) or an insulated gate bipolar transistor (IGBT), is driven with a pulse signal and pulse width modulation (PWM) is performed while changing the cycle or the length of the pulse signal is generally used.

The power-transmitting power conversion circuit is a power conversion circuit which converts electric power supplied from the external power source 23 to DC power according to the power-transmitting DC/AC conversion circuit and supplies DC power to the power-transmitting-side DC/AC conversion circuit. When AC power is supplied from the external power source 23, the power-transmitting power conversion circuit is, for example, a rectifier circuit which is constituted of diodes, and may have a configuration in which a DC/DC converter having a function of boosting, deboosting, or boosting/deboosting is combined, or a configuration having a power factor improvement (PFC) function. When DC power is supplied from the external power source 23, the power-transmitting power conversion circuit may be omitted so that the power-transmitting DC/AC conversion circuit may be directly connected to the external power source 23, or may be a DC/DC converter having a function of boosting, deboosting, or boosting/deboosting. The converter, which is used, may be a non-insulation type (a chopper or the like) or an insulation type (using a transformer or the like).

The power-transmitting controller includes a CPU, a storage device, an input/output buffer, and the like, and receives signals from the sensors or the like or outputs control signals to the instruments. The power-transmitting controller controls power transmission based on the type, the charged state, or the like of the automobile 3. The power-transmitting controller stops power transmission when any abnormality which requires stopping the wireless power supply is detected on the power-receiving device 10.

The wireless communication device performs wireless communication with the wireless communication device provided in the power-receiving power conversion circuit 12 through an antenna using a short range communication standard, such as Bluetooth (Registered Trademark).

The external power source 23 is, for example, a commercial power source, a solar cell, wind power generation, or the like, and supplies electric power to the power-transmitting power conversion circuit.

Next, the circuit configuration of the wireless power-supplying system 1 will be described referring to FIG. 2.

FIG. 2 is a diagram illustrating the circuit configuration of the wireless power-supplying system 1 according to the embodiment of the invention. In FIG. 2, for simplification of description, the power-transmitting DC/AC conversion circuit, the power-transmitting power conversion circuit, and the like in a power-receiving circuit 30 are omitted, and the power-receiving power conversion circuit and the like in a power-transmitting circuit 40 are omitted.

The wireless power-supplying system 1 has the power-receiving circuit 30 provided with the power-receiving coil 31 and the power-transmitting circuit 40 provided with the power-transmitting coil 41. The power-receiving circuit 30 is connected to the battery 13. The power-transmitting circuit 40 is connected to the external power source 23.

The power-receiving circuit 30 is provided with a capacitor 32 of the power-receiving pad 11 and a variable resistor 33 (impedance changer), in addition to the power-receiving coil 31 of the power-receiving pad 11. The capacitor 32 is connected in parallel to the power-receiving coil 31.

The variable resistor 33 changes the impedance of the power-receiving circuit 30 when requiring stopping the wireless power supply. The variable resistor 33 is connected in series to the power-receiving coil 31, and may be a part of the power-receiving pad 11 or the power-receiving power conversion circuit 12, or may be separated from the power-receiving pad 11 and the power-receiving power conversion circuit 12. The variable resistor 33 changes the resistance value under the control of the power-receiving controller. The variable resistor 33 of this embodiment changes the resistance value rapidly, and for example, changes the resistance value in a stepped manner.

As the variable resistor 33, for example, a method is known, in which a plurality of circuits each having a controllable switch and a resistor connected in series are connected in parallel, and a combined resistance value is changed by switching the switches. As the controllable switch, an electronic switch, such as an FET, in which conduction or non-conduction is switched by changing the voltage of a gate signal, a relay or a contactor in which a contact is switched by changing a current for driving a coil, or the like is used.

The power-transmitting circuit 40 is provided with a capacitor 42 of the power-transmitting pad 21, a current sensor 43 (impedance change detector), and a voltage sensor 44 (impedance change detector), in addition to the power-transmitting coil 41 of the power-transmitting pad 21. The capacitor 42 is connected in series to the power-transmitting coil 41. As the current sensor 43, for example, a sensor which measures a magnetic field generated in proportion to a current around a power cable using the Hall effect to measure a current, a sensor which inserts a resistor into a power cable, measures the potential difference between both ends of the resistor, and measures a current using the potential difference between both ends of the resistor being in proportion to the current, or the like is used. As the voltage sensor 44, for example, a sensor which divides a voltage by a resistor, converts the voltage to a digital value by an AD (Analog to Digital) converter, and measures the digital value is used.

The current sensor 43 and the voltage sensor 44 measure the current and the voltage of the power-transmitting circuit 40, and are connected to the power-transmitting controller. The wireless power-supplying system 1 of this embodiment detects change in impedance by the variable resistor 33 based on the current value of the current sensor 43 and the voltage value of the voltage sensor 44.

The battery 13 of this embodiment uses a constant-current/constant-voltage charged type (CC-CV type). For this reason, the variable resistor 33 changes a step by which the resistance value changes according to the charged mode of the battery 13. Specifically, the variable resistor 33 changes impedance by a first change step when the battery 13 is in a constant-current charged mode (CC), and changes impedance by a second change step greater than the first change step when the battery 13 is in a constant-voltage charged mode (CV).

The constant-current charged mode is a mode to limit a maximum current for the battery 13 at the earlier charged stage at which a large current is likely to flow due to a low battery voltage. In the constant-current charged mode, even when the step of a change of the resistance value by the variable resistor 33 is small, the current value of the power-receiving circuit 30 can be easily changed and the power-transmitting circuit 40 can easily detect a change in the impedance of the power-receiving circuit 30. The first change step of the variable resistor 33 in the constant-current charged mode is referred to as A.

The constant-voltage charged mode is a mode to limit a voltage for the battery at the later charged stage at which the current value is decreased, and the battery voltage is increased. In the constant-voltage charged mode, the current value of the power-receiving circuit 30 is not easily changed, and if the step of a change of the resistance value by the variable resistor 33 is small, the power-transmitting circuit 40 may not detect a change in impedance of the power-receiving circuit 30. For this reason, the variable resistor 33 sets the second change step in the constant-current charged mode to B greater than the first change step A. For example, the relationship of B>2A is established.

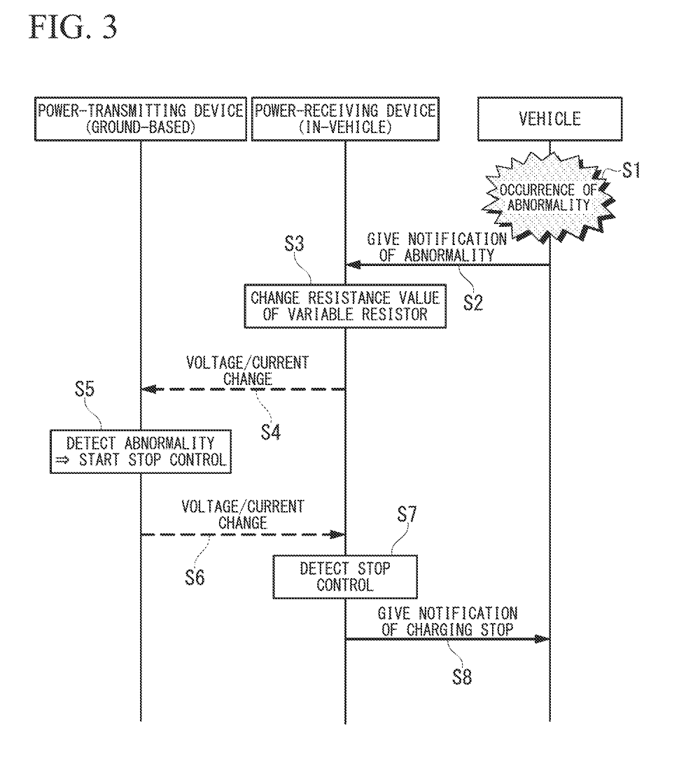

Next, in the wireless power-supplying system 1, an operation from when an abnormality occurred during the wireless power supply is detected until the wireless power supply is stopped will be described referring to FIG. 3.

FIG. 3 is a flowchart from when abnormality occurs in the wireless power-supplying system according to the embodiment of the invention until the wireless power supply is stopped.

First, when any abnormality which requires stopping the wireless power supply occurs in the automobile 3 (Step S1), an abnormality notification is sent to the power-receiving device 10 (Step S2). Any abnormality which requires stopping the wireless power supply includes not only an event (for example, the frequency band of a radio wave from a satellite passing over the sky affecting the wireless power supply) which may disable or interfere with the wireless power supply, but also the completion of charging of the battery 13, or the like.

Then, the power-receiving device 10 which receives the abnormality notification changes the resistance value of the variable resistor 33 (Step S3). If the resistance value of the power-receiving circuit 30 is changed by the variable resistor 33, the impedance of the power-receiving circuit 30 is changed. In this embodiment, the power-receiving controller controls the change step of the variable resistor 33, based on the charged mode of the battery 13 at the time of the reception of the abnormality notification. When the battery 13 is in the constant-current charged mode, the variable resistor 33 changes the impedance of the power-receiving circuit 30 by the first change step. When the battery 13 is in the constant-voltage charged mode, the variable resistor 33 changes the impedance of the power-receiving circuit 30 by the second change step greater than the first change step.

The change in the impedance of the power-receiving circuit 30 is reflected in change in voltage/current to the power-transmitting circuit 40 through the electromagnetic field between the power-receiving coil 31 and the power-transmitting coil 41 (Step S4). The power-transmitting circuit 40 is provided with the current sensor 43 and the voltage sensor 44, and when the change in voltage/current occurs with a step not to be observed during normal operation, the current sensor 43 and the voltage sensor 44 detect change in impedance by the variable resistor 33. Specifically, a threshold value of the step of the voltage/current based on change during normal operation is stored in advance in the storage device of the power-transmitting controller, and when the step of the voltage/current exceeds the threshold value, it is determined that abnormality occurs (Step S5).

If abnormality is detected, the power-transmitting device 20 starts stop control of the wireless power supply. The stop control is performed by the power-transmitting controller connected to the power-transmitting DC/AC conversion circuit and the power-transmitting power conversion circuit. If the stop control of the wireless power supply is started, the impedance of the power-transmitting circuit 40 is changed. The change in the impedance of the power-transmitting circuit 40 is reflected in change in voltage/current to the power-receiving circuit 30 through the electromagnetic field between the power-receiving coil 31 and the power-transmitting coil 41 (Step S6). The power-receiving device 10 detects the stop control is performed on the power-transmitting device 20 based on the change in voltage/current (Step S7). The power-receiving controller gives a notification to the effect that the wireless power supply is stopped on the monitor of the automobile 3 or the like (Step S8).

As described above, according to this embodiment, the variable resistor 33 is provided in the power-receiving circuit 30 provided with the power-receiving coil 31 to change the impedance of the power-receiving circuit 30 when requiring stopping the wireless power supply. The change in the impedance of the power-receiving circuit 30 causes a change in voltage or current in the power-transmitting circuit 40 through the electromagnetic field between the power-receiving coil 31 and the power-transmitting coil 41. In this embodiment, the current sensor 43 or the voltage sensor 44 provided in the power-transmitting circuit 40 detects the change in the voltage or current as a trigger to stop the wireless power supply. In this way, the wireless power supply is stopped by detecting the change in impedance when the power-receiving circuit 30 is viewed from the power-transmitting circuit 40, whereby it is not necessary to use wireless communication.

Even when the change in impedance of the power-receiving circuit 30 is not transmitted to the power-transmitting circuit 40 using a signal or the like, the change in impedance is spontaneously reflected in the circuit behavior of the power-transmitting circuit 40. For this reason, it is possible to stop power transmission reliably and quickly compared to wireless communication which is easily affected by the ambient environment.

In this embodiment, the power-receiving circuit 30 is connected to the constant-current/constant-voltage charged type battery 13, and the variable resistor 33 changes impedance by the first change step when the battery 13 is in the constant-current charged mode and changes impedance by the second change step greater than the first change step when the battery 13 is in the constant-voltage charged mode. According to this configuration, since the impedance of the power-receiving circuit 30 can be changed corresponding to the charged mode of the battery 13, it is possible to more reliably perform abnormality detection in the power-transmitting circuit 40.

Accordingly, according to this embodiment, the wireless power-supplying system 1 which performs wireless power supply using the power-receiving coil 31 and the power-transmitting coil 41 has a configuration in which the power-receiving circuit 30 provided with the power-receiving coil 31 has the variable resistor 33 which changes impedance when requiring stopping the wireless power supply, the power-transmitting circuit 40 provided with the power-transmitting coil 41 has the current sensor 43 and the voltage sensor 44 which detect change in impedance by the variable resistor 33, and the wireless power supply is stopped based on the detection results of the current sensor 43 and the voltage sensor 44, whereby the wireless power-supplying system 1 capable of stopping the wireless power supply quickly and reliably is obtained.

Although the preferred embodiment of the invention has been described referring to the drawings, the invention is not limited to the foregoing embodiment. The shapes, the combinations, and the like of the components shown in the above-described embodiment are just an example, and various changes may be made based on a design request or the like without departing from the scope of the invention.

For example, in the foregoing embodiment, although a case where the impedance changer is the variable resistor 33 provided in the power-receiving circuit 30 has been described, the invention is not limited to this configuration. Any impedance changer may be used as long as the impedance changer can change the impedance of the power-receiving circuit 30, and for example, may have a configuration in which a parallel circuit provided with a resistor is added to the power-receiving circuit 30 and a resistance value is switched by switching, or may be a variable coil or a variable capacitor.

For example, in the foregoing embodiment, although a case where the impedance change detector is the current sensor and the voltage sensor provided in the power-transmitting circuit 40 has been described, the invention is not limited to this configuration. Depending on the circuit configuration of the power-transmitting circuit 40, change in impedance of the power-receiving circuit 30 can be detected by either the current sensor or the voltage sensor.

For example, in the foregoing embodiment, although a case where power transmission is performed from the road surface 2 to the bottom of the automobile 3 has been described, the direction is not considered. For example, a configuration may be made, in which power transmission is performed from a wall to the side of the automobile 3 or the front or rear of the automobile 3, or power transmission is performed from a ceiling to the roof of the automobile 3.

For example, in the foregoing embodiment, although a case where the power-receiving device 10 is provided in the automobile 3 and the power-transmitting device 20 is provided on the road surface 2 has been illustrated, the invention is not limited to this configuration, and for example, a configuration may be made, in which the power-receiving device 10 is provided on the road surface 2 and the power-transmitting device 20 is provided in the automobile 3.

The invention can be applied to even when at least one of the power-receiving device and the power-transmitting device is provided in a vehicle, such as an automobile or a train, or even when at least one of the power-receiving device and the power-transmitting device is provided in a mobile object, such as a vessel, a submarine, or an aircraft.

For example, in the foregoing embodiment, although the current sensor and the voltage sensor are provided between the capacitor and the coil of the power-transmitting pad 21, the invention is not limited to this configuration, and for example, the current sensor and the voltage sensor may be provided at the input end of the inverter circuit on the power-transmitting side of the wireless power-supplying system 1.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description and is only limited by the scope of the appended claims.

What is claimed is:

1. A wireless power-supplying system configured to perform wireless power supply using a power-receiving coil and a power-transmitting coil,
wherein a power-receiving circuit provided with the power-receiving coil has impedance changer configured to change impedance when requiring stopping the wireless power supply,
a power-transmitting circuit provided with the power-transmitting coil has impedance change detector configured to detect change in impedance by the impedance changer, and
the wireless power supply is stopped based on a detection result of the impedance change detector.

2. The wireless power-supplying system according to claim 1,
wherein the impedance changer has a variable resistor provided in the power-receiving circuit.

3. The wireless power-supplying system according to claim 1,
wherein the impedance change detector has at least one of a current sensor and a voltage sensor provided in the power-transmitting circuit.

4. The wireless power-supplying system according to claim 2,
wherein the impedance change detector has at least one of a current sensor and a voltage sensor provided in the power-transmitting circuit.

5. The wireless power-supplying system according to claim 1,
wherein the power-receiving circuit is connected to a constant-current/constant-voltage charged type rechargeable device, and
the impedance changer changes impedance by a first change step when the rechargeable device is in a constant-current charged mode and changes impedance by a second change step greater than the first change step when the rechargeable device is in a constant-voltage charged mode.

6. The wireless power-supplying system according to claim 2,
wherein the power-receiving circuit is connected to a constant-current/constant-voltage charged type rechargeable device, and
the impedance changer changes impedance by a first change step when the rechargeable device is in a constant-current charged mode and changes impedance by a second change step greater than the first change step when the rechargeable device is in a constant-voltage charged mode.

7. The wireless power-supplying system according to claim 3,
wherein the power-receiving circuit is connected to a constant-current/constant-voltage charged type rechargeable device, and
the impedance changer changes impedance by a first change step when the rechargeable device is in a constant-current charged mode and changes impedance by a second change step greater than the first change step when the rechargeable device is in a constant-voltage charged mode.

8. The wireless power-supplying system according to claim 4,
wherein the power-receiving circuit is connected to a constant-current/constant-voltage charged type rechargeable device, and
the impedance changer changes impedance by a first change step when the rechargeable device is in a constant-current charged mode and changes impedance by a second change step greater than the first change step when the rechargeable device is in a constant-voltage charged mode.
